(19) United States
(12) Patent Application Publication
(10) Pub. No.: US 2008/0144276 A1
(43) Pub. Date: Jun. 19, 2008

(54) COMPUTER ENCLOSURE WITH I/O PLATE

(75) Inventors: ZHAO-BIN YANG, Shenzhen (CN); ZHONG-QUN LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/738,528

(22) Filed: Apr. 23, 2007

(30) Foreign Application Priority Data
Dec. 15, 2006 (CN) 200620016486.9

(51) Int. Cl. G06F 1/16

(52) U.S. Cl. 361/686; 361/825

(57) ABSTRACT

A computer enclosure includes a rear wall (10) and an I/O plate (20). The rear wall defines an opening (12) therein. The opening has two opposite edges. A positioning tab (16) is formed on one of the opposite edges of the opening. The I/O plate is shaped for covering the opening of the rear wall. The I/O plate has two opposite edges and defines a cutout (242) at one of the two opposite edges thereof configured for the positioning tab inserting therethrough. A positioning tab (248) is formed on and cooperates with the other one of the opposite edges of the I/O plate for slidably sandwiching the other one of the opposite edges of the opening therebetween. A protrusion (246) is formed on the I/O plate configured for engaging into the opening of the rear wall to prevent the I/O plate sliding to align the cutout thereof with the positioning tab of the rear wall.

### BACKGROUND

1. Technical Field

The present invention relates to computer enclosures, and more particularly to a computer enclosure with an I/O (Input/Output) plate.

2. General Background

A computer enclosure includes a rear wall. The rear wall defines an opening therein. An I/O plate is usually provided to cover the opening of the rear wall. Conventionally, the I/O plate is usually secured on the rear wall with screws or rivets. However, it is very inconvenient to assemble or disassemble the I/O plate.

Another I/O plate has four side walls respectively bent perpendicularly from four edges of the I/O plate in a same direction, and four positioning flanges respectively bent perpendicularly out from the corresponding side walls. A plurality of protrusions is formed on each side wall adjacent to each corresponding positioning flange. Due to resilient deformation of the side walls, the protrusions of the I/O plate can be slid across the corresponding edges of the opening of the rear wall when the I/O plate is inserted into the opening. The edges of the openings of the rear wall are sandwiched between the positioning flanges and the protrusions of the I/O plate, so that the I/O plate is secured on the rear wall. However, the I/O plate easily becomes loosened by vibrations generated within the computer enclosure.

What is needed, therefore, is a computer enclosure having an I/O plate conveniently and stably secured on a rear wall of the computer enclosure.

### SUMMARY

A computer enclosure includes a rear wall and an I/O plate. The rear wall defines an opening therein. The opening has two opposite edges. A positioning tab is formed on one of the opposite edges of the opening. The I/O plate is shaped configured for covering the opening of the rear wall. The I/O plate has two opposite edges and defines a cutout at one of the two opposite edges thereof for the positioning tab inserting therethrough. A positioning tab is formed on, and cooperates with, the other one of the opposite edges of the I/O plate for slidably sandwiching the other one of the opposite edges of the opening therebetween. A protrusion is formed on the I/O plate configured for engaging into the opening of the rear wall to prevent the I/O plate sliding to align the cutout thereof with the positioning tab of the rear wall.

Other advantages and novel features will be drawn from the following detailed description of preferred embodiments with attached drawings, in which:

### BRIEF DESCRIPTION OF THE DRAWINGS

FIG. 1 is an exploded, isometric view of a rear wall and a I/O plate of a computer enclosure in accordance with a preferred embodiment of the present invention;

FIG. 2 is similar to FIG. 1, but viewed from another aspect;

FIG. 3 is an assembled view of FIG. 1; and

FIG. 4 is an assembled view of FIG. 2.

### DETAILED DESCRIPTION OF PREFERRED EMBODIMENTS

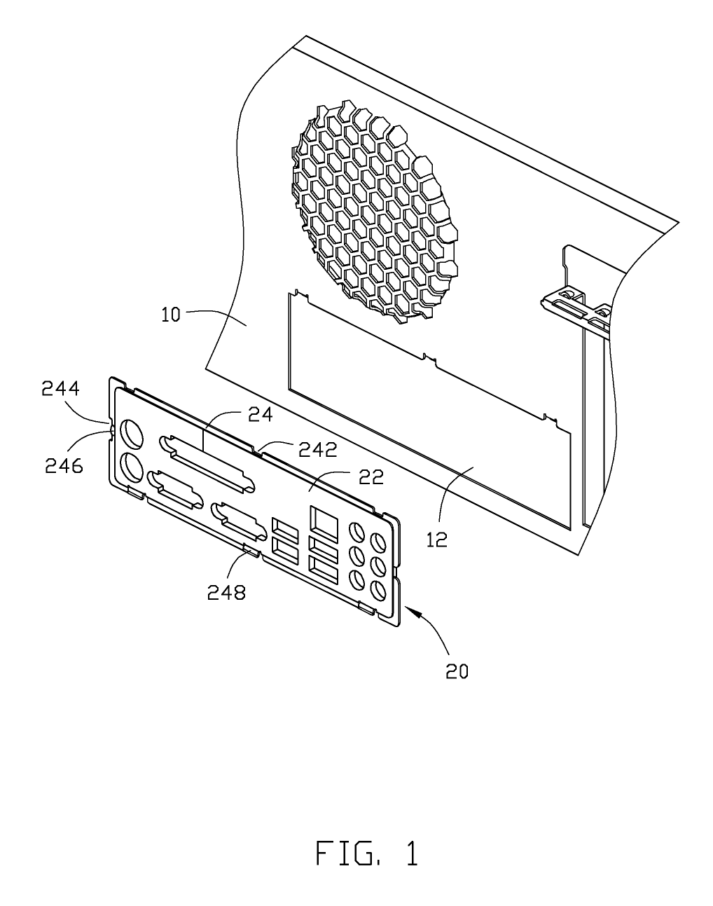

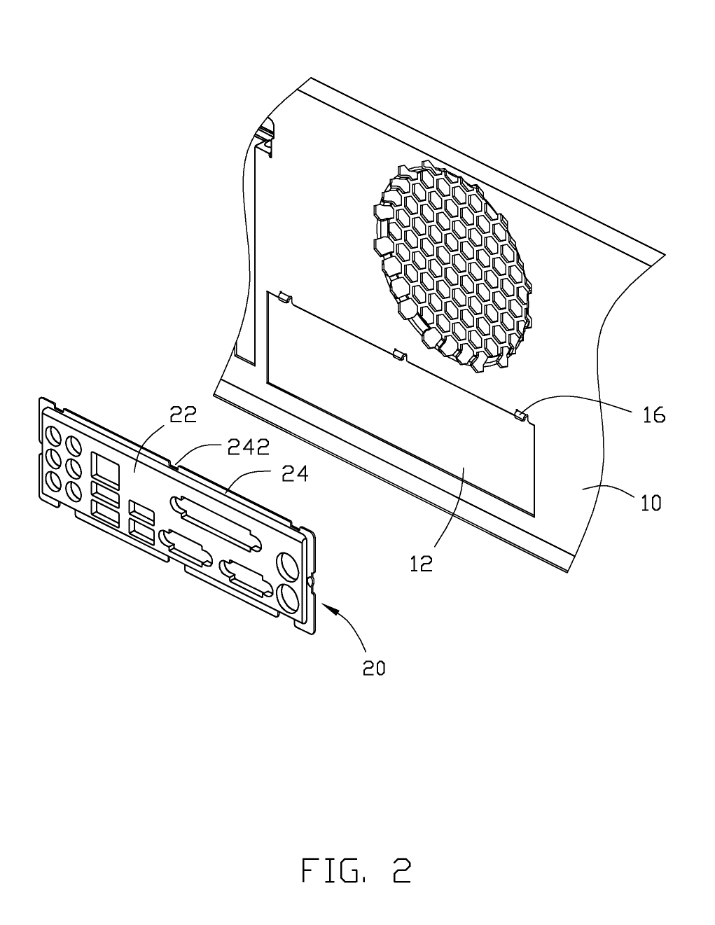

Referring to FIGS. 1 and 2, a computer enclosure includes a rear wall 10. A rectangular opening 12 is defined in the rear wall 10. The opening 12 has a top edge, a bottom edge parallel to the top edge, and a pair of parallel side edges perpendicular to the top edge. A plurality of generally L-shaped positioning tabs 16 is formed on the top edge inside the rear wall 10.

An I/O plate 20 is shaped to cover the opening 12 of the rear wall 10, and has a base portion 22 formed thereon, for attachment of an EMI (Electro Magnetic Interference) gasket (not labeled) thereon, and a plurality of rims 24 extending from four outer edges of the base portion 22. A plurality of I/O holes (not labeled) is defined in the base portion 22 for receiving corresponding electronic connectors. A plurality of cutouts 242 is defined in a top rim 24, corresponding to the positioning tabs 16 of the rear wall 10. A plurality of generally L-shaped positioning tabs 248 is formed inward from a bottom rim 24. A cutout 244 is defined in one side rim 24. A protrusion 246 is formed on a side edge of the cutout 244.

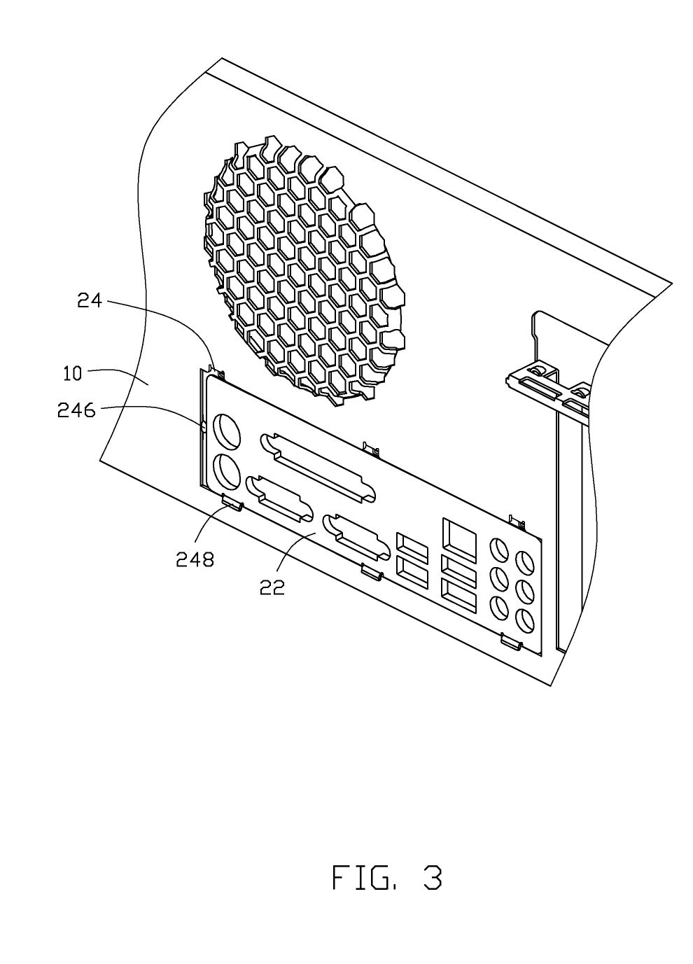

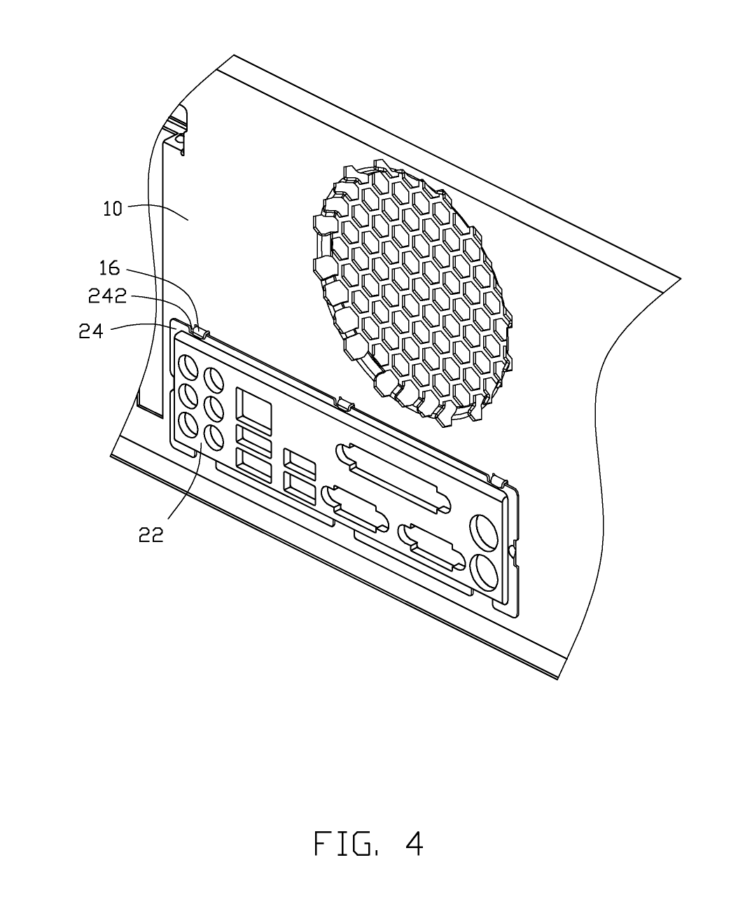

Referring also to FIGS. 3 and 4, the I/O plate 20 is attached on the rear wall 10 from inside of the computer enclosure. The bottom edge of the opening 12 is slidably sandwiched between the positioning tabs 248 and the bottom rim 24 of the I/O plate 20. The I/O plate 20 is slid rightward (viewed from FIG. 4) until the protrusion 246 contacts the edge of the opening 12. The right side rim 24 at which the protrusion 246 is formed, is pushed inward which results in the plate 20 being deformed and the protrusion 246 being removed from the edge of the opening 12. The I/O plate 20 is further slid rightward until the cutouts 242 align with the corresponding positioning tabs 16 of the rear wall 10. The positioning tabs 16 of the rear wall 10 are inserted through the corresponding cutouts 242 of the I/O plate 20. The right side rim 24 is released. The plate 20 rebounds to its original state to cause the right side rim 24 to move outward which results in the protrusion 246 abutting against the side edge of the opening 12 and the plate 20 moving leftward a distance to cause the cutouts 242 offset from the corresponding positioning tabs 16. The top rim 24 is slidably sandwiched between the positioning tabs 16 and the inner surface of the rear wall 10. The interaction between the protrusion 246 and the corresponding one side edge of the opening 12 prevents the I/O plate 20 sliding rightward so that the I/O plate 20 is securely located on the rear wall 10.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A computer enclosure comprising:
a rear wall defining an opening therein, the opening having a first edge, an opposite second edge and a side edge interconnecting the first edge and the second edge, a wall cutout being defined in the first edge and communicating with the opening, a positioning tab being formed on the first edge of the opening and located adjacent to the wall cutout; and
an I/O plate covering the opening of the rear wall, the I/O plate having a first plate edge and an opposite second plate edge and a cutout defined in the first plate edge thereof configured for allowing the positioning tab to be insertable therein, a positioning tab being formed on the second plate edge of the I/O plate, the positioning tab of the I/O plate and the second plate edge thereof sandwiching the second edge of the opening therebetween, a protrusion being formed on the I/O plate abutting against the side edge in of the opening of the rear wall, the cutout being offset from the positioning tab of the rear wall.

2. The computer enclosure as described in claim 1, wherein the rear wall has two opposite surface, the positioning tab of the rear wall being formed on one of the opposite surfaces, the positioning tab of the I/O plate being located on the other one of the opposite surfaces of the rear wall.

3. The computer enclosure as described in claim 1, wherein the I/O plate includes a base portion and a plurality of rims extending from edges of the base portion, the cutout and the positioning tab of the I/O plate being formed on the rims thereof.

4. A computer enclosure comprising:
a rear wall defining an opening therein;
a resiliently deformable I/O plate being shaped for covering the opening of the rear wall, a protrusion being formed on the I/O plate; and
a guideway being formed on the rear wall and the I/O plate for the I/O plate being slidably and releasably attached to the rear wall;
wherein the I/O plate is resiliently deformed so that the protrusion engages in the opening of the rear wall, and the protrusion engages against an edge of the opening to block the I/O plate from sliding on the rear wall after the I/O plate rebounds to an original state.

5. The computer enclosure as described in claim 4, wherein the guideway comprises a positioning tab formed on a top edge of the opening of the rear wall.

6. The computer enclosure as described in claim 5, wherein the I/O plate defines a cutout therein for the positioning tab of the rear wall inserting therethrough.

7. The computer enclosure as described in claim 4, wherein the guideway comprises a positioning tab formed on a bottom edge of the I/O plate configured for slidably clasping a bottom edge of the opening.

8. A computer enclosure comprising:
a wall defining an opening therein, the opening having two opposite edges, a positioning tab extending from one of the opposite edges of the opening; and
an I/O plate being shaped for covering the opening of the rear wall, the I/O plate having two opposite edges one defining a cutout corresponding to the positioning tab of the wall and the other one forming another positioning tab thereon, the positioning tab of the I/O plate and the other one of the opposite edges of the I/O plate clasping the other one of the opposite edges of the opening therebetween, so that the I/O plate is rotated about the engagement between the I/O plate and the other one of the opposite edges of the opening until the positioning tab of the wall inserts through the cutout of the I/O plate, the one of the opposite edges of the I/O plate being inserted between the positioning tab of the wall and the one of the opposite edges of the opening after the I/O plate is slid to offset the positioning tab of the wall from the cutout of the I/O plate, a protrusion being formed on the I/O plate and engaging with the rear wall to prevent the I/O plate sliding to align the cutout with the positioning tab of the rear wall.

9. The computer enclosure as described in claim 8, wherein the I/O plate comprises a base covering the opening, and a plurality of rims extending from a periphery of the base and abutting against an inner surface of the I/O plate around the opening.

10. The computer enclosure as described in claim 9, wherein the positioning tab of the wall and the inner surface of the I/O plate sandwich one of the rims located at the one of the opposite edges of the I/O plate therebetween, and the another positioning tab of the plate and another one of the rims of the I/O plate sandwich the other one of the opposite edges of the opening therebetween.

11. The computer enclosure as described in claim 9, wherein the protrusion protrudes outward from one of the rims located between two opposite edges of the plate configured for engaging with one corresponding edge of the opening, when the one of the rims is pushed inward to disengage the protrusion from the corresponding edge of the opening the I/O plate is capable of being slid toward the corresponding edge of the opening to align the cutout with the positioning tab of the rear wall, whereby the I/O plate is removable from the wall.
